(19) United States
(12) Patent Application Publication
(10) Pub. No.: US 2009/0203441 A1
(43) Pub. Date: Aug. 13, 2009

(54) Skateboard video controller

(75) Inventors: Russ Piccoli, Paradise Valley, AZ (US); Charles Lasek, Olivenhain, CA (US); Brad Lusky, San Marcos, CA (US)

Correspondence Address: ETHERTON LAW GROUP, LLC, 2010 E. University Drive, Suite 25, Tempe, AZ, 85281, US

(73) Assignee: X Sports Collectables, LLC

(21) Appl. No.: 12/069,756

(22) Filed: Feb. 13, 2008

(51) Int. Cl. G06F 17/00

(52) U.S. Cl. 463/36

(57) ABSTRACT

A player-actuated video game controller simulates a skateboard or other footboard such that the player stands on the controller and pitches or rolls the deck to cause directional movement of a character on a display. A system of biasing springs between the deck and the base of the controller resist the player's movement of the deck in order to simulate a realistic ride. The number, size, tension, and placement of the springs increases the realism of the ride beyond that of known devices. The controller uses a motion sensor to detect motion of the deck and transmits motion data to a video game system. The controller is augmented by a handheld controller to provide button-based functionality.

### FIELD OF INVENTION

This invention relates to electronic data processing in a video game. This invention relates particularly to a player-actuated control structure that simulates a realistic ride on a skateboard or other board-sport implement while controlling a figure in a video game.

### BACKGROUND

To play a video game, a player generally requires a video game system, a display, and a controller. There may be many controllers from which to choose to control the action on the display. Video game systems dedicated solely to playing video games, such as the Microsoft Xbox® and Sony Playstation®, are called consoles. Consoles have a standard controller that is sold with the console, and the console manufacturer may produce upgraded, but similar, controller models. Additionally, an industry of after-market controllers has developed around video gaming. Many manufacturers in this industry sell controllers that are adapted to a specific genre of gaming, such as racing, golf, and skateboarding and other board-related sports. Genre-specific controllers improve the gaming experience by moving the action from hand-manipulated controls to more realistic devices, such as steering wheels and pedals, golf clubs, and footboards including skateboards, surfboards, and snowboards.

Many footboard controllers increase realism at the expense of functionality. When moving the controller from the hands to the feet, the buttons beneath the player's fingers can no longer be used. Consequently, the number of signals the controller can send to the video game system is greatly reduced. This problem has been addressed by combining the footboard controller, for directional input, with a handheld controller to make additional button-activated features available.

Several methods are known in the art for detecting the movements of the player while standing on a footboard controller. Button-based systems, switch-based systems, and motion sensors have been employed to achieve varying degrees of accuracy in reflecting movements. Current motion sensors can capture very small movements and so are thought to transmit the most accurate motion information to the video game system. The smaller the movement recognized by the sensor, the more precise the response within the video game system. A character on the display therefore responds to very small directional changes as well as drastic pitches and rolls of the footboard controller.

The realism of a footboard controller is limited due to its stationary nature. The controller is not actually moving along the surface of the street, snow, or wave, and so friction and other physical forces that would be present in real life do not affect the footboard. Additionally, the size and riding style of the user changes the response of the footboard, so different people must use different equipment to attain the same level of performance. Existing devices attempt to compensate for the lack of realism by applying tension to the footboard using a biasing system, such as a series of springs, between the deck and the base of the controller. Spring-based biasing systems are favored due to the low cost of materials, and in some cases the spring tension may be adjusted to accommodate different sizes and styles of users.

The size and placement of the springs affects the realism of the simulation. A typical footboard is much longer than it is wide and therefore turning left and right by tilting the deck to one side or the other is much easier than pitching the deck forward or backward. On real skateboards, trucks and wheels attached to the bottom of the deck enhance the turning effect and provide resistance to the user's movements. However, in the case of skateboard simulations, a footboard controller does not have trucks or wheels and therefore does not respond to the user's movements as a real skateboard would. Existing footboard controllers with springs placed in linear or rectangular configurations do not address these elements. A linear configuration fails to duplicate the resistance applied to the left and right edges of the skateboard deck, while a rectangular configuration does not simulate a skateboard's natural pivot about the axis formed by the connection of the trucks to the skateboard deck. It would be advantageous to resist both pitch and roll motions.

Known spring configurations call for the springs to be perpendicular to the footboard and the base of the controller. In such a configuration, the springs are prone to crimping or bending rather than compressing during substantial tilting of the footboard. Under such force the springs may bend irregularly outside of the natural compression motion, called a “pop,” causing unwanted noise and uneven movement in the footboard. The resulting ride is far less smooth than a real footboard and the popping may cause incorrect input to the video game system if the footboard controller uses a motion sensor that detects the uneven movement. Additionally, the springs may be damaged or permanently misshaped by the crimping or bending action. A spring configuration that allows the springs to compress properly under an expected degree of force is needed.

Another problem with spring-based biasing systems is that the performance of the springs begins to degrade under constantly changing forces. This eventually causes the springs to squeak under the application and release of force. The squeaking is not native to real-life footboards. A spring system that does not squeak is needed.

Therefore, it is an object of this invention to provide an apparatus for controlling a video game that simulates the ride of a real footboard such as a surfboard, snowboard, or skateboard. It is a further object that the device reacts to the movements of a user as similarly as possible to the reaction of a real footboard. Another object of the invention is that the device be adjustable to accommodate different users. Another object is to position the springs so they properly compress without detracting from the realistic feel of the controller. Another object of the invention is to eliminate unwanted squeaking caused by subjecting the footboard controller to frequent use. A further object is to provide a footboard controller with functionality that is augmented by a handheld controller.

### SUMMARY OF THE INVENTION

A footboard deck is mounted on a stable base using a dual pivot that allows the footboard deck to roll right and left and pitch forward and backward. A motion sensor detects these movements and transmits signals representing the direction and degree of rotation to a video game unit, which translates the signals into commands to move a player-controlled figure in the video game. In order to make the physical response of the footboard controller to the user's movements emulate riding on an actual surfboard, snowboard, or skateboard, a plurality of springs are biased between the base and the footboard deck, and angled such that when the user tilts the footboard deck, forces resembling resistance to the tilting which would occur on an actual footboard are applied to points on the footboard deck.

In the preferred embodiment, four springs are positioned in a diamond shape around the dual pivot along the axes defined by the dual pivot. The left and right springs are angled away from the dual pivot and the fore and aft springs are more resistive and angled toward the dual pivot. This angling scheme provides very high resistance to pitch rotations and, during roll movements, allows proper compression of the left and right springs. The tension of the springs is adjustable to increase and decrease the stability of the skateboard deck. Rubber baffles are inserted between the coils of the springs to further control the spring tension, prevent squeaking, and provide a more realistic ride.

### BRIEF DESCRIPTION OF THE DRAWINGS

FIG. 1 is an elevation view of the right side of a video controller of the present invention.

FIG. 2 is an elevation view of the right side of the dual pivot and spring configuration of the present invention.

FIG. 3 is an elevation view of the rear of a video controller of the present invention.

FIG. 4 is an elevation view of the front of a video controller of the present invention.

FIG. 5 is a top view of the present invention, with the motion sensor, spring configuration, and dual pivot shown in dotted lines.

FIG. 6 is a cross-section of a spring column taken along line 4-4 of FIG. 4.

FIG. 7 is a perspective close-up view of the dual pivot of the present invention.

### DETAILED DESCRIPTION OF THE INVENTION

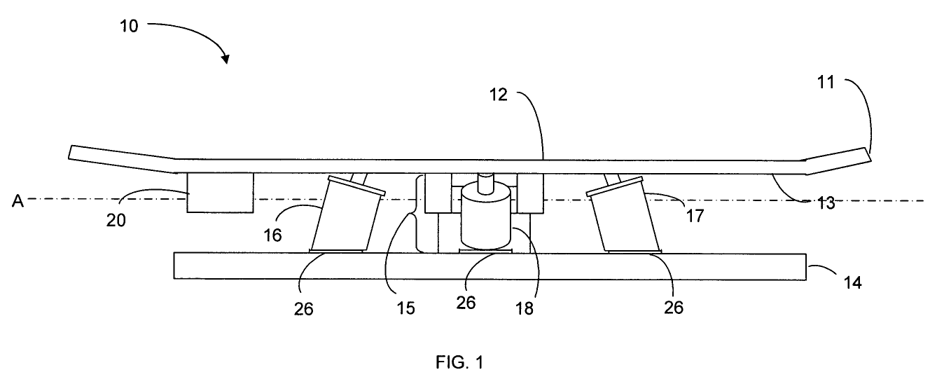

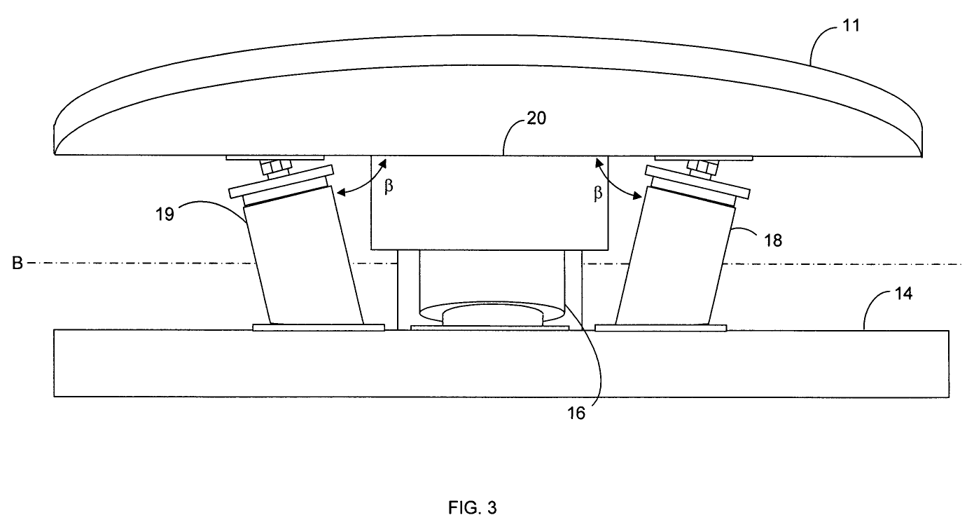

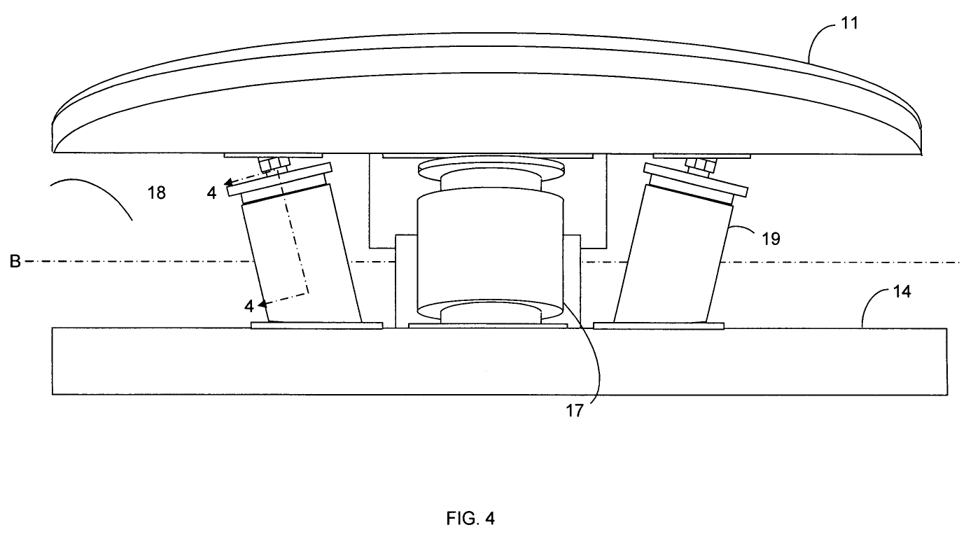

FIGS. 1-5 illustrate top and side views of the preferred embodiment of the present invention, designated generally as a footboard controller 10, which simulates the ride of a skateboard or other footboard when a player uses it to control the action in a video game. A footboard deck 11 having a top surface 12 and a bottom surface 13 is connected to a base 14 by way of a pivot structure 15. At rest, the footboard deck 11 and base 14 are substantially parallel. The footboard deck 11 may be substantially planar or may be shaped to resemble a footboard used in board sports, such as a skateboard, snowboard, or surfboard. In the preferred embodiment the footboard deck 11 resembles a skateboard deck in that it is elliptical with upturned ends. The pivot structure 15, described in detail below, allows the player to rotate the footboard deck 11 relative to the base 14 while the player stands on the footboard deck 11. The pivot structure 15 can be any structure that connects the footboard deck 11 to the base 14, supports the footboard deck 11 at a predetermined distance above the base 14, and facilitates roll motions toward the left and right and pitch motions toward the fore and aft of the footboard deck 11. The pivot structure 15 may include a ball joint and socket, a universal joint, two single-axis pivots working in tandem, or a combination of such structures. In the preferred embodiment, the pivot structure 15 is a combination of two single-axis pivots that define a lengthwise axis A around which roll motions are performed, and a widthwise axis B around which pitch motions are performed. The plane defined by the axes A and B is horizontally parallel to the footboard deck 11 when it is at rest. The optimum location of the pivot structure 15 with respect to the footboard deck 11 depends on the type of structure used. For example, a single ball joint and socket is most effective at the intersection of the lengthwise and widthwise centerlines of the footboard deck 11, herein referred to as the center of the footboard deck 11, while a combination of two ball joint and socket structures should be spaced widely apart along the lengthwise centerline of the footboard deck 11. In the preferred embodiment, the single-axis pivots are combined into a single structure located at the center of the footboard deck 11.

A motion sensor 20 detects the movements of the board and outputs corresponding signals to a video game system either wirelessly or through a connecting cable (not pictured). The motion sensor 20 includes a microcontroller that converts the signals generated by sensing motion into data that can be interpreted by the video game system, as is known in the art. Preferably, the motion sensor 20 also includes a sensitivity control (not pictured) that allows the user to adjust the motion sensor's 20 interpretation of the intensity of the movements. For example, at a low sensitivity setting the motion sensor 20 may signal the video game system of the degree of rotation of the footboard deck 11 at intervals of ten degrees from the rest orientation, while at a high sensitivity setting a signal is sent for every two degrees of rotation. A proficient user may therefore exert more precise control over the display data by increasing the sensitivity of the motion sensor 20.

A handheld controller (not pictured) may be connected to the motion sensor 20 to transmit button-based signals for use in conjunction with the motion signals generated by the motion sensor 20. The motion sensor 20 would then coordinate the button-based and motion signals and transmit the coordinated data to the video game system. Alternatively, the handheld controller may transmit input directly to the video game system for coordination with input transmitted by the motion sensor 20. The player may use this coordinated data to activate “tricks” associated with button combinations by pressing the buttons on the handheld controller and moving the footboard deck 11 simultaneously. A simple example from a skateboard simulation is performing a “kickturn,” where the simulated character raises the front skateboard wheels off the ground and spins the skateboard 180 degrees clockwise or counterclockwise, so that the character is facing the opposite direction from before the kickturn. The player would depress and hold a button on the handheld controller to raise the simulated front skateboard wheels, and then the player would tilt the footboard controller in the direction he wants the simulated skateboard to spin, releasing the button to drop the simulated front wheels to the ground at a desired point. In the preferred embodiment, the footboard controller 10 is configured to plug into a standard controller port in a console such as a Sony Playstation®, Playstation2®, or Playstation3®, and the handheld controller to be used in conjunction with the footboard controller 10 connects to the motion sensor 20 and is designed to function like a standard controller for the console. In an alternate embodiment, the footboard controller 10 is configured to plug into a Universal Serial Bus (USB) or COM serial port in a personal computer and the handheld controller connects to a separate USB or COM port.

The response of a real footboard to a rider's pitch or roll movements is simulated in the footboard controller 10 by using a biasing system, such as hydraulic or pneumatic pistons, lever arms, or springs, to apply resistance to the footboard deck 11. In the preferred embodiment, the biasing system uses springs. A spring configuration comprises a plurality of spring columns, each of which has multiple parts. The number, size, angle, and location of the spring columns affect how the player feels the footboard deck 11 responding to his movements. The choices made within the configuration may require modification of the other configuration elements in order to maximize the realism of the simulation. For example, the optimum location for each spring column is different if the configuration includes four spring columns rather than six, or if some spring columns are larger than others, rather than all spring columns being of equal size. In order to maximize realism, the footboard controller 10 preferably utilizes at least four spring columns. Further, the spring columns should be angled as described below to achieve an improvement in realism over non-angled spring configurations. The preferred embodiment illustrated in the figures and described below is recognized as the best mode of achieving improved realism over the prior art.

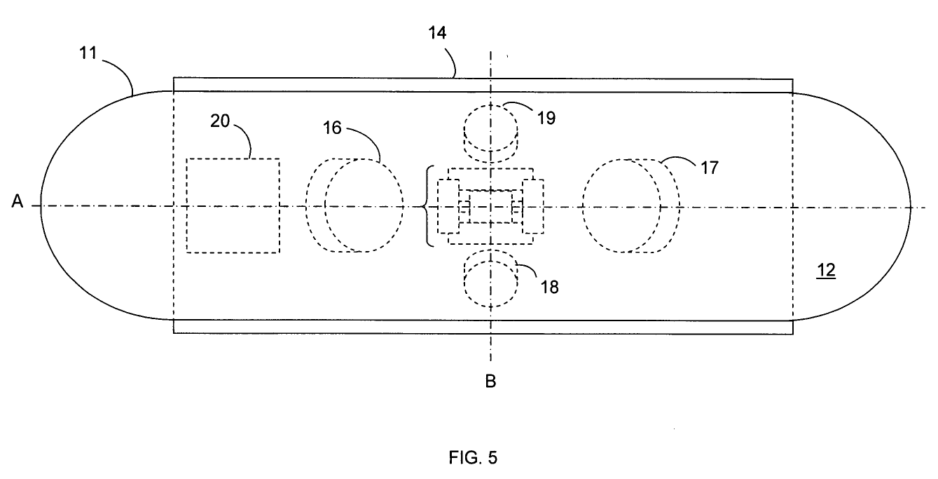

The preferred spring configuration comprises four spring columns 16-19 arranged in a diamond shape along the axes A and B. See FIG. 5. The aft spring column 16 and fore spring column 17 contain more resistive springs than the right spring column 18 and left spring column 19. This arrangement provides greater resistance to pitch motions than to roll motions. Spring resistance may be increased by any method that gives the fore and aft springs a higher spring constant than the left and right springs, including changing the material composition of the spring, increasing the density of the spring coils, and increasing the diameter of the spring. In the preferred embodiment, the aft spring column 16 and fore spring column 17 contain springs having a larger diameter and thicker coils than the right spring column 18 and left spring column 19. The aft spring column 16 and fore spring column 17 are angled with respect to the footboard deck 11, forming the acute angle α. This reduces the torque on the spring columns and allows the springs therein to compress and expand in a direction parallel to the axis of the cylinder formed by the spring. This smoothes pitch movements and prevents jolting due to bending or improperly compressed springs. Angle α may be any angle that promotes a realistic ride, but is preferably between 70 and 80 degrees, and most preferably 75 degrees.

The right spring column 18 and left spring column 19 contain less resistive springs, allowing a greater degree of rotation in the footboard deck 11 during roll movements. Experimentation revealed that the right spring column 18 and left spring column 19 remained prone to bending when angled toward the pivot structure 15 like the other columns. It was determined that bending was eliminated by angling the right spring column 18 and left spring column 19 with respect to the footboard deck 11, forming the acute angle β. The angle also allows the springs therein to compress and expand in a direction parallel to the axis of the cylinder formed by the spring. This smoothes roll movements and prevents noise and uneven riding due to bending or improperly compressed springs. Angle β may be any angle that promotes a realistic ride. In the preferred embodiment, angle β is between 70 and 80 degrees, inclusive, but most preferably 75 degrees.

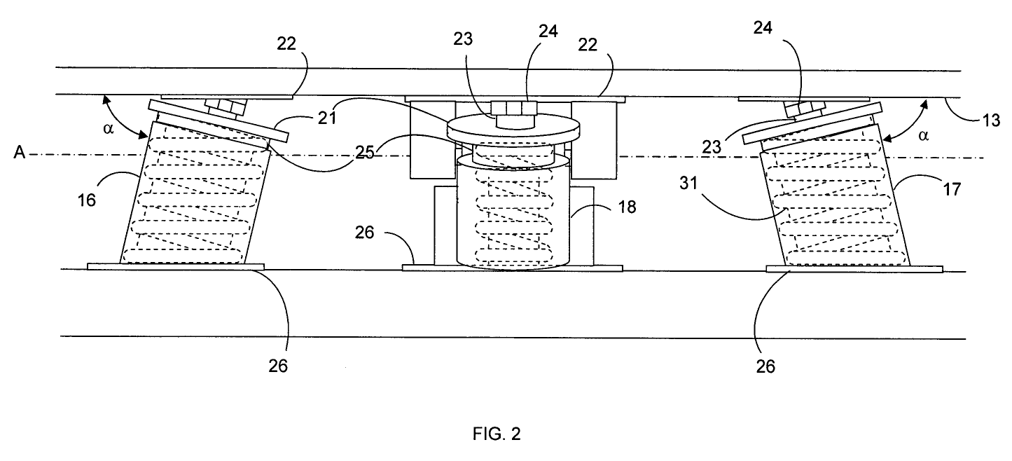

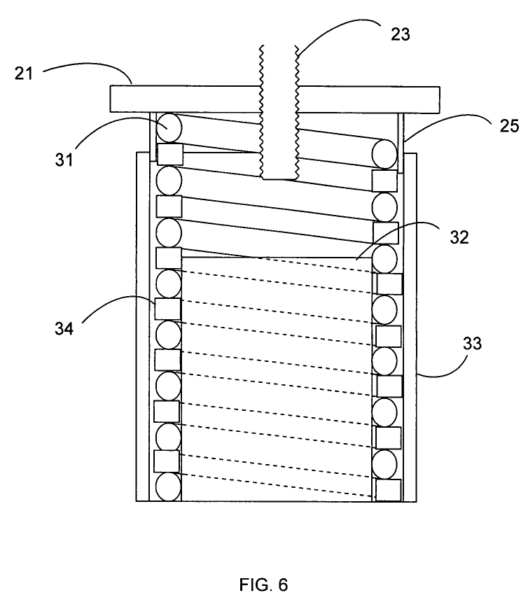

The spring columns each comprise the same parts. See FIGS. 2 and 6. A spring column is attached to the bottom surface 13 of the footboard deck 11 using a connector plate 22. In the preferred embodiment, the connector plate 22 includes a threaded nut 24 into which a screw 23 is inserted. The screw 23 is attached to an adjustor 21, which is also threaded. When the adjustor 21 is rotated, the threads engage the threads on the screw 23 and the adjustor compresses the spring 31 as it moves toward the base 14. The at-rest compression of each spring 31 can therefore be adjusted to control the amount of resistance offered by each spring column. The adjustor 21 is attached to a sleeve 25. The sleeve 25 fits over the spring 31 to secure the spring 31 within the spring column and keep the spring 31 in contact with the adjustor 21. The spring column is attached to the base 14 using a base plate 26. In the preferred embodiment, the spring column is permanently attached to the base plate 26 by welding or soldering the column core 32 to the base plate 26. In alternate embodiments, the spring 31 is adhesively attached to the base plate 26, and the column core 32 may be attached to the base plate 26 or free-floating.

FIG. 6 is a cross-section of the spring column showing the spring 31, column core 32, sheath 33, and baffles 34. The spring 31 is a compression spring and may be composed of any material typically used in compression springs, including standard steel, Inox steel, steel composites such as chromium-silicon steel, zinc-coated wire, and polymer composites. The column core 32 is a rigid cylinder that fits inside the spring 31 and protects against bending during compression of the spring 31. The column core 32 can be any material suitable to help maintain the shape of the spring 31, such as plastic or metal, and may be tubular or solid. In the preferred embodiment, the column core 32 is a thick tube of plastic. The spring 31 is protected by a flexible sheath 33 which is the part of the spring column pictured in FIGS. 1-4. The sheath 33 may be any material suitable for preventing accumulation of debris around the spring, but also cannot itself be caught between the spring coils. In the preferred embodiment, the sheath 33 is made of a thin polyurethane shell similar to a section of corrugated plastic tubing.

The spring column may further comprise one or more baffles 34 placed between the coils of the spring 31. The baffles 34 prevent squeaking caused by the coils rubbing against each other or against the column core 32. Additionally, the baffles 34 may be made of a material that increases the overall resistance offered by the spring 31. The compressibility of the baffles 34 determines the amount of resistance added as well as the point during spring compression at which the increase in resistance engages. In the preferred embodiment, the baffles 34 are made of rubber and placed between each coil. The rubber is composed so that it offers minimal resistance to compression until the spring has reached about 20% of its maximum compression, at which point the baffles 34 begin to resist compression and the player encounters more resistance to his rotating movements. The baffles 34 may naturally stay in place or may be held between the coils by adhesive or friction against the sheath 33 or column core 32 or both parts. Alternatively, the baffles may be created by coating the spring 31 in rubber or another material that contributes to the spring's 31 overall resistance to compression.

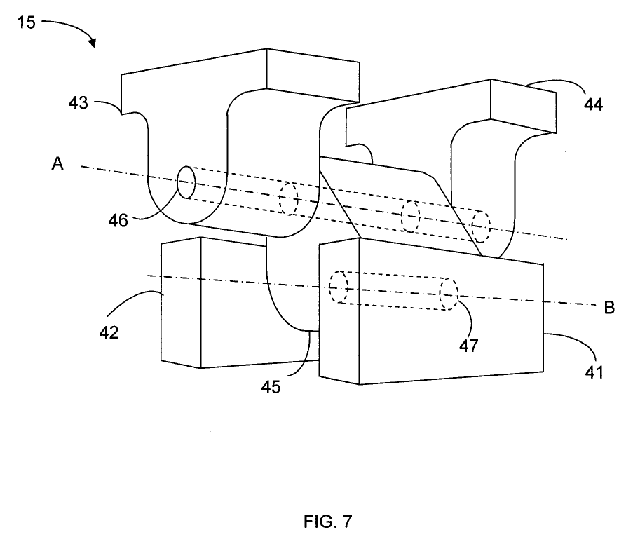

Referring to FIG. 7, the pivot structure 15 is designed to create a dual pivot around axes A and B. The right base block 41 and left base block 42 are attached to the base 14, and aft block 43 and fore block 44 are attached to the footboard deck 11. Attachment may be by adhesive or non-adhesive means. In the preferred embodiment, the blocks are bolted to their respective support surfaces. The center block 45 is positioned between the right base block 41 and the left base block 42 and a widthwise axle 47 passes through the lengthwise midpoint of the center block 45, connecting the base blocks 41 and 42. The center block 45 is also positioned between the aft block 43 and the fore block 44 and a lengthwise axle 46 passes through the widthwise midpoint of the center block 45, connecting the aft block 43 and fore block 44. In the preferred embodiment, the lengthwise axle 46, forming the axis A around which rolling movements are made, passes through the center block 45 above the widthwise axle 47, which forms the axis B allowing pitch movements. While the pivot structure 15 of the preferred embodiment may be located anywhere between the footboard deck 11 and base 14 that allows for these movements, the realism of the movements is maximized by placing it at the center of the footboard deck 11.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. A video controller having a base, a footboard deck attached to the base allowing the footboard deck to pitch and roll, a motion sensor attached to the footboard deck, and a microcontroller configured to receive sensing signals from the motion sensor, the improvement comprising:
a) a plurality of biasing mechanisms, each engaging the base and footboard deck such that at least one of the biasing mechanisms offers resistance to pitching and at least one of the biasing mechanisms offers resistance to rolling;
wherein the biasing mechanisms offering resistance to pitching are angled toward the center of the footboard deck and the biasing mechanisms offering resistance to rolling are angled away from the center of the footboard deck.

2. The video controller of claim 1 wherein the biasing mechanisms offering resistance to pitching are more resistive than the biasing mechanisms offering resistance to rolling.

3. The video controller of claim 1 further comprising a pivot structure connected to the footboard deck and the base, wherein the pivot structure defines a lengthwise axis and a widthwise axis around which the footboard deck rotates.

4. The video controller of claim 3 wherein the pivot structure is at about the center of the footboard deck.

5. The video controller of claim 1 wherein the biasing mechanisms are springs.

6. The video controller of claim 5 further comprising a baffle positioned between the coils of each spring.

7. The video controller of claim 6 wherein the baffle is rubber.

8. The video controller of claim 5 having at least two springs that offer resistance to pitching and at least two springs that offer resistance to rolling.

9. The video controller of claim 5 wherein the springs are arranged in a diamond shape around a pivot structure such that two springs are located on the lengthwise axis and two springs are located on the widthwise axis.

10. A video controller having a base, a footboard deck attached to the base such that the footboard deck is allowed to pitch and roll, a motion sensor operably connected to the footboard deck, and a microcontroller configured to receive signals from the motion sensor, the improvement comprising:
a) four spring columns, each spring column engaging the footboard deck and the base, and each spring column comprising:
i. a spring having coils, a top, and a bottom;
ii. a column core inside the cylinder formed by the coils;
iii. a sleeve fitting over the top of the spring; and
iv. an adjustor connected to the sleeve such that moving the adjustor changes the at-rest compression of the spring;
wherein each spring column is angled with respect to the footboard deck.

11. The video controller according to claim 10 wherein each spring column further comprises:
a) a baffle positioned between each coil of the spring; and
b) a sheath connected to the sleeve and covering the spring.

12. The video controller according to claim 10 further comprising a pivot structure connected to the footboard deck and the base, wherein the pivot structure defines a lengthwise axis around which the footboard deck rolls and a widthwise axis around which the footboard deck pitches.

13. The video controller of claim 12 wherein the pivot structure is located at about the center of the footboard deck.

14. The video controller of claim 10 wherein the spring columns are arranged in a diamond shape around the pivot structure such that two spring columns are located on the lengthwise axis and two spring columns are located on the widthwise axis.

15. The video controller of claim 14 wherein the two spring columns located on the lengthwise axis are angled toward the pivot structure and the two spring columns located on the widthwise axis are angled away from the pivot structure.

16. The video controller of claim 15 wherein each spring column located on the lengthwise axis contains a spring that is more resistive than each spring in the two spring columns located on the widthwise axis.

17. A video controller having a base, a footboard deck attached to the base such that the footboard deck is allowed to pitch and roll, a motion sensor operably connected to the footboard deck, and a microcontroller configured to receive signals from the motion sensor, the improvement comprising:
a) four spring columns, each spring column engaging the footboard deck and the base, each spring column comprising:
i. a spring having coils, a top, and a bottom;
ii. a column core inside the cylinder formed by the coils;
iii. a sleeve fitting over the top of the spring; and
iv. an adjustor connected to the sleeve such that moving the adjustor changes the at-rest compression of the spring;
v. a baffle positioned between each coil; and
vi. a sheath fitting over the outside of the spring; and
b) a pivot structure connected to the footboard deck and the base, wherein the pivot structure defines a lengthwise axis around which the footboard deck rolls and a widthwise axis around which the footboard deck pitches, the pivot structure located at about the center of the footboard deck;
wherein:
i. two spring columns are positioned on the widthwise axis on either side of the pivot structure and are angled away from the pivot structure at an angle α,
ii. two spring columns are positioned on the lengthwise axis on either side of the pivot structure and are angled toward the pivot structure at an angle β; and
iii. the two spring columns positioned on the lengthwise axis each contain a spring that is more resistive than the spring in the spring columns positioned on the widthwise axis.

18. The video controller of claim 17 in which α is 75 degrees.

19. The video controller of claim 17 in which β is between 70 degrees and 80 degrees.

20. The video controller of claim 17 in which α is 75 degrees and β is 75 degrees.
